(19) United States
(12) Patent Application Publication
(10) Pub. No.: US 2026/0077629 A1
(43) Pub. Date: Mar. 19, 2026

(54) PRESSURE CONTROLLED MULTI-MODE MULTI-WAY VALVE FOR WATER SPRAY DISTRIBUTION ON RADIATOR FOR FUEL CELL ELECTRIC VEHICLE

(71) Applicant: FCA US LLC, Auburn Hills, MI (US)

(72) Inventor: Matthew Bartlett, Auburn Hills, MI (US)

(21) Appl. No.: 18/886,345

(22) Filed: Sep. 16, 2024

(51) Int. Cl. B60H 1/00; B60H 1/32; H01M 8/04007

(52) U.S. Cl. CPC B60H 1/00278; B60H 1/00885; B60H 1/3202; H01M 8/04074; H01M 2250/20

(57) ABSTRACT

A thermal management system for a vehicle having a fuel cell stack is provided. The thermal management system includes a radiator, a storage reservoir, a pump, a valve assembly and a controller. The valve assembly selectively delivers the liquid product water to a drain and to a first spray manifold that sprays the liquid product water at the radiator. The valve assembly includes: a first valve assembly disposed in a drain valve chamber of the valve housing and having a first biasing member that biases a first pin against a first inlet, the first valve assembly selectively communicating the liquid product water to the drain; and a second valve assembly disposed in a second valve chamber of the valve housing and having a second biasing member that biases a second pin against a second inlet, the second valve assembly selectively communicating the liquid product water to the first spray manifold.

### FIELD

The present application relates generally to fuel cell vehicles and, more particularly, to a fuel cell vehicle with a water cooled thermal system.

### BACKGROUND

Some vehicles include proton exchange membrane (PEM) fuel cells for motive power. Such PEM fuel cells have the advantage of rejecting less total heat than internal combustion engines. However, the amount of heat rejected to the cooling system is higher and such cooling systems often have a reduced maximum allowable coolant temperature. Moreover, when PEM fuel cells are installed in vehicles designed for internal combustion engines, there is often insufficient space to install large enough radiators and fans to provide sufficient heat rejection capability for desired vehicle performance, such as towing a trailer on steep grades. As such, cooling system performance potentially limits vehicle performance. Accordingly, while such fuel cell systems work for their intended purpose, there is a desire for improvement in the relevant art.

### SUMMARY

In accordance with one example aspect of the invention, a thermal management system for a vehicle having a fuel cell stack is provided. The thermal management system includes a radiator, a storage reservoir, a pump, a valve assembly and a controller. The radiator is thermally coupled to the fuel cell stack. The storage reservoir stores liquid product water from the fuel cell stack. The pump pumps liquid product water. The valve assembly receives the liquid product water from the pump, the valve assembly having a valve housing that selectively delivers the liquid product water to a drain and to a first spray manifold that sprays the liquid product water at the radiator. The valve assembly includes: a first valve assembly disposed in a drain valve chamber of the valve housing and having a first biasing member that biases a first pin against a first inlet, the first valve assembly selectively communicating the liquid product water to the drain; and a second valve assembly disposed in a second valve chamber of the valve housing and having a second biasing member that biases a second pin against a second inlet, the second valve assembly selectively communicating the liquid product water to the first spray manifold, the first biasing member having a distinct spring rate from the second biasing member wherein a first water pressure opens the first inlet of the first valve assembly without the second valve assembly opening the second inlet. The controller commands the pump to increase RPM in a first Mode from the first water pressure to a second water pressure, wherein the second water pressure is higher than the first water pressure and causes the first valve assembly to close and the second valve assembly to open the second inlet.

In addition to the foregoing, the controller commands the pump to increase RPM in a first Mode from the first water pressure to a second water pressure, wherein the second water pressure is higher than the first water pressure and causes the first valve assembly to close and the second valve assembly to open the second inlet.

In addition to the foregoing, the described thermal management system may include a third valve assembly disposed in a third valve chamber of the valve housing and having a third biasing member that biases a third pin against a third inlet, the third valve assembly selectively communicating the liquid product water to a second spray manifold, the third biasing member having a distinct spring rate from the second biasing member wherein a third water pressure, higher than the first and second water pressures, opens the third valve assembly communicating the liquid product water to the second spray manifold.

In addition to the foregoing, the first valve assembly includes a drain armature having a first scallop configuration defined on a perimeter thereof.

In addition to the foregoing, the second valve assembly includes a second armature having a second scallop configuration defined on a perimeter thereof, the second scallop configuration being distinct from the first scallop configuration.

In addition to the foregoing, the described thermal management system may include a first plurality of spray nozzles configured at the first spray manifold.

In addition to the foregoing, the described thermal management system may include a second plurality of spray nozzles configured at the second spray manifold.

In other features, the pump is a LIN pump that provides feedback to the controller indicative of a dry-run condition.

In additional features, the pump is a LIN pump that measures electrical current and voltage and provides a signal to the controller indicative of a pump RPM.

In other examples, the first valve assembly wherein the first pin is an upstream pin selectively biased against a first inlet, the first valve assembly further comprising a downstream pin that is selectively biased against a first outlet that leads to the drain.

According to additional features, the upstream and downstream pins are positioned away from the first inlet and outlet, respectively with the first water pressure.

In other features, the downstream pin moves to a closed position at the first outlet with the second water pressure.

In additional features, the valve housing comprises an upstream valve chamber at a first housing section that receives the liquid product water prior to entering any of the first and second valve assemblies formed at a second housing section.

In other examples, the first and second housing sections are ultrasonically welded together.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example thermal management system for a fuel cell vehicle, in accordance with the principles of the present application;

FIG. 2A is a sectional illustration of an example valve assembly shown in FIG. 1, in accordance with the principles of the present application;

FIG. 2B is a top view of the example valve assembly shown in FIG. 2A;

FIG. 2C is a sectional view of the valve assembly of FIG. 3A illustrating an exemplary armature configuration;

FIG. 3A is a top view of a valve assembly constructed in accordance to additional features of the present disclosure;

FIG. 3B is a sectional view of the valve assembly of FIG. 3A illustrating an exemplary armature configuration;

FIG. 4 is a table illustrating various operating modes of the thermal management system of FIG. 1;

FIG. 5A is a schematic illustration of the thermal management system shown operating in a diagnostics mode according to various examples of the present disclosure;

FIG. 5B is a schematic illustration of the thermal management system shown operating in an OFF mode according to various examples of the present disclosure;

FIG. 5C is a schematic illustration of the thermal management system shown operating in a drain mode according to various examples of the present disclosure;

FIG. 5D is a schematic illustration of the thermal management system shown operating in a spray mode 1 according to various examples of the present disclosure;

FIG. 5E is a schematic illustration of the thermal management system shown operating in a spray mode 2 according to various examples of the present disclosure; and

FIG. 5F is a schematic illustration of the thermal management system shown operating in a spray mode 3 according to various examples of the present disclosure.

### DETAILED DESCRIPTION

As mentioned above, PEM fuel cells are installed in vehicles designed for internal combustion engines, there is often insufficient space to install large enough radiators and fans to provide sufficient heat rejection capability for desired vehicle performance, such as towing a trailer on steep grades. As such, cooling system performance potentially limits vehicle performance.

According to the principles of the present application, systems and methods are described for a thermal management system for a fuel cell powered electric vehicle. The thermal management system is configured to capture water created in a hydrogen fuel cell stack (FCS), and subsequently spray the product water onto a high temperature radiator for cooling of the thermal system. The thermal system includes a valve assembly that selectively distributes the water to one or more spray nozzle manifolds, or to a drain line depending upon an amount of water pressure delivered by a smart pump. A controller commands the pump to deliver a desired pressure to the valve assembly and control the radiator fan based on operating conditions.

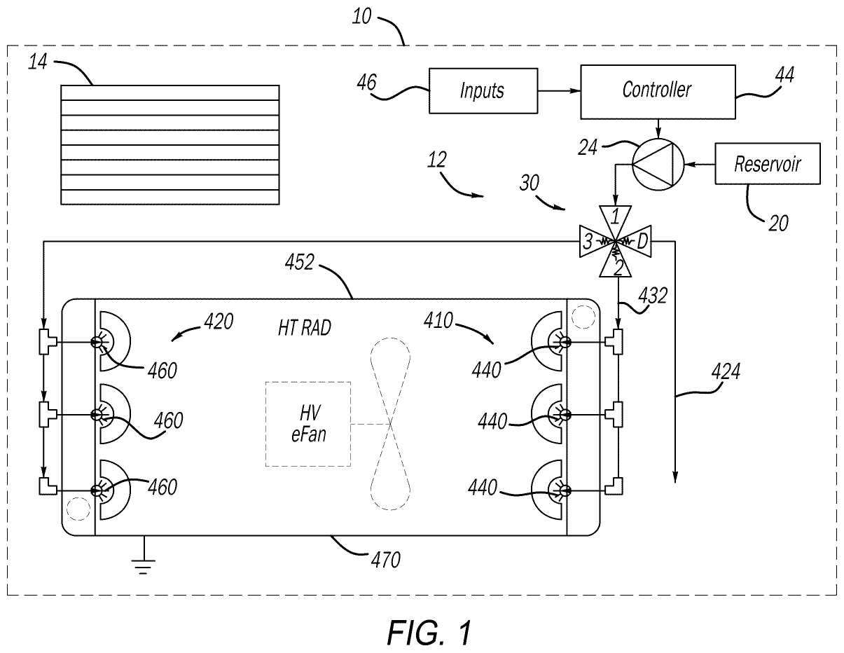

With reference now to FIG. 1, a vehicle fuel cell system 10 with an associated thermal management system 12 is illustrated in accordance with the principles of the present disclosure. The vehicle fuel cell system 10 generally includes a fuel cell stack 14, a hydrogen fuel source and oxygen fuel source (not specifically shown). In the example embodiment, the fuel cell stack 14 is a proton exchange membrane (PEM) fuel cell stack formed by stacking a plurality of fuel cells, which are configured to generate electricity by electrochemical reactions of a fuel gas (e.g., hydrogen) and an oxygen containing gas (e.g., ambient air). As is well known in the art, each fuel cell includes an electrolyte membrane disposed between an anode and a cathode. It will be appreciated, however, that the thermal management system 12 described herein may be utilized with various other types of fuel cell systems.

In the example embodiment, the thermal management system includes a storage reservoir 20 that stores liquid product water. A pump 24 is configured to pump the water from the reservoir 20 into a main valve assembly 30. A controller 44 communicates a signal to the pump 24 indicative of a desired pressure based on inputs 46 received. As will become appreciated from the following discussion, the valve assembly 30 selectively opens and closes ports based on the water pressure to selectively deliver the water to desired locations.

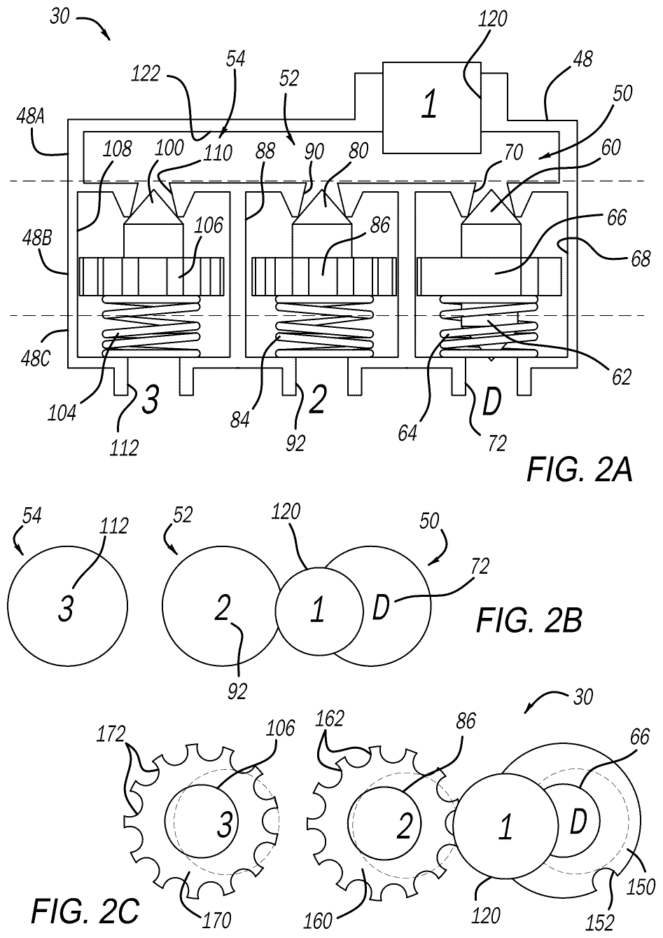

With continued reference to FIG. 1 and additional reference to FIGS. 2A-2C, the valve assembly 30 will be further described. The valve assembly 30 includes a valve housing 48 that houses a first or drain valve assembly 50, a second valve assembly 52 and a third valve assembly 54. Water pressure increases (and decreases) based on an RPM of the pump 24. The valve assemblies are normally closed until the pressure from the pump 24 overcomes a biasing force of a biasing member causing a valve to open. By using biasing members of different rates, a sequence of valve openings is realized as pump RPM and pressure are increased. The pump 24 is a local interconnect network (LIN) controlled smart pump and has the ability to measure operating states which is also part of the control strategy implemented by the controller 44. Drain mode runs until the reservoir 20 is empty and the pump 24 detects a dry-run condition and shuts off. Likewise, as the pump RPM is controlled by the controller 44, the pump 24 measures electrical current and voltage and provides a signal to the controller 44 that each RPM is achieved.

In the example embodiment shown, the drain valve assembly 50 generally includes a first or upstream tapered valve member or pin 60, a downstream tapered valve member or pin 62, a first biasing member 64 and a first drain armature 66 disposed within a drain valve chamber 68. The upstream and downstream tapered pins 60, 62 translate to open and close a first inlet 70 and a first outlet 72 defined in the valve housing 48.

The second valve assembly 52 generally includes a second upstream tapered valve member or pin 80, a second biasing member 84 and a second drain armature 86 disposed within a second valve chamber 88. The upstream tapered pin 80 translates to open and close a second inlet 90 that receives water before it flows out of a second outlet 92 defined in the valve housing 48.

The third valve assembly 54 generally includes a third upstream tapered valve member or pin 100, a third biasing member 104 and a third drain armature 106 disposed within a third valve chamber 108. The upstream tapered pin 100 translate to open and close a third inlet 110 that receives water before it flows out of a third outlet 112 defined in the valve housing 48.

In examples, the valve housing 48 can be formed of plastic material and further defines a main valve inlet 120 that leads to an upstream valve chamber 122. The valve housing 48 can further be formed by housing sections 48A, 48B and 48C (identified at dashed lines in FIG. 2A) that can be ultrasonically welded during an assembly process that locates the respective valve assemblies 50, 52 and 54 within the valve housing 48.

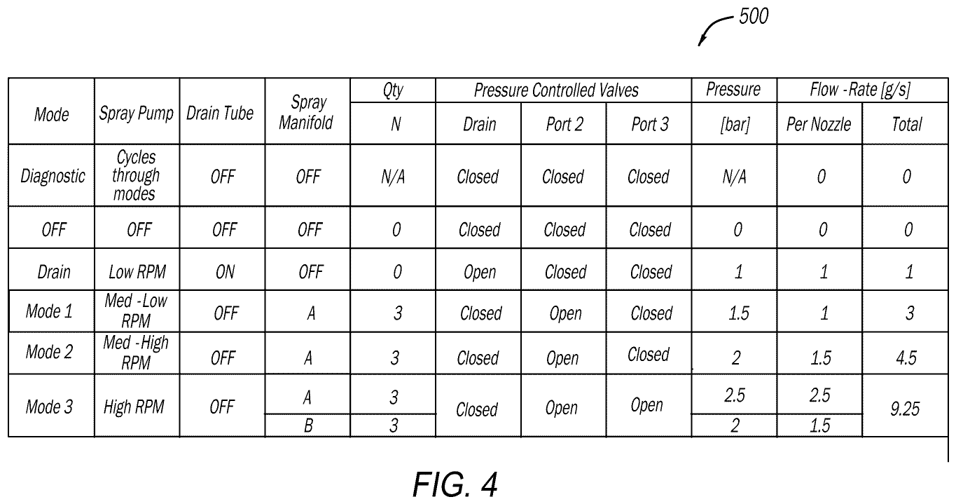

According to the present disclosure, the spring rates of the first, second and third biasing members 64, 84 and 104 are distinct. In the example described herein, the first biasing member 64 has a lower spring rate compared to the second biasing member 84. The second biasing member 84 has a lower spring rate compared to the third biasing member 104. In this regard, the first biasing member 64 will compress based on a water pressure that enters the upstream valve chamber 122 before the second biasing member 84. Similarly, the second biasing member 84 will compress based on a water pressure that enters the upstream valve chamber 122 before the third biasing member 104. As a result, the valve assembly 30 distributes water in multiple modes (further described with respect to FIG. 4) to satisfy various spray and cooling strategies.

With particular reference now to FIG. 2C, the armatures 66, 86 and 106 will be further described. The armatures 66, 86 and 106 define various scallops around their perimeters. The scallops act as a tunable feature to control the position of the armature when the inlet (70, 90, 110) is open. Water pressure loss occurs across the armature based on the total scallop cross-section. In the example shown, the first armature 66 includes a first disk 150 having a scallop 152 defined around a perimeter thereof. The second armature 86 include a second disk 160 having a plurality of scallops 162 defined around a perimeter thereof. The third armature 106 includes a third disk 170 having a plurality of scallops 172 defined around a perimeter thereof.

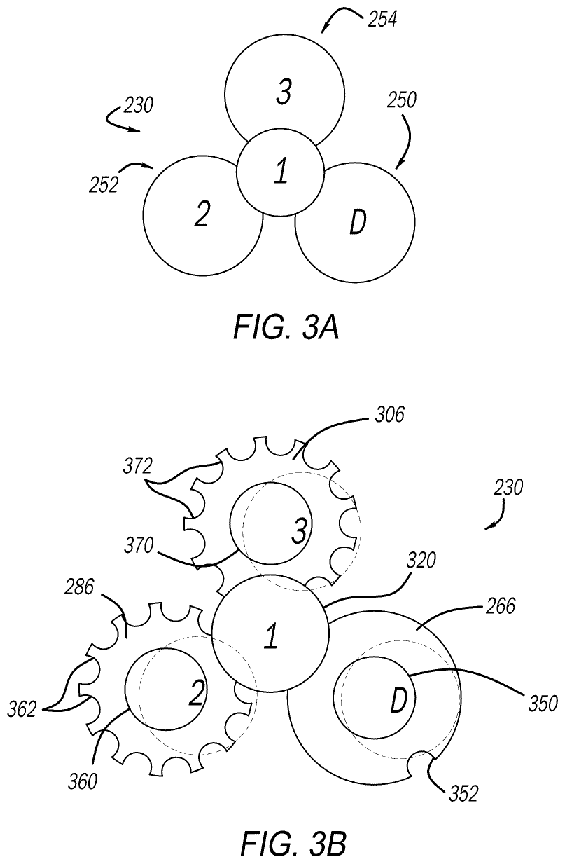

FIGS. 3A and 3B illustrate a valve assembly 230 having an alternate valve configuration wherein a first valve assembly 250, a second valve assembly 252 and a third valve assembly 254 are arranged in a triangular fashion. The valve assembly 230 can include similar components as the valve assembly 30 and identified with like reference numerals increased by 200.

Returning to FIG. 1, the valve assembly 30 selectively opens and closes the first inlet 70, the first outlet 72, the second inlet 90 and the third inlet 110 based on the water pressure to selectively deliver the water out of the first, second and third outlets 72, 92 and 112 to desired locations including a first spray manifold 410, a second spray manifold 420 and a drain line 424. In the example shown, the second valve assembly 52 opens the second inlet 90 to deliver water through first delivery lines 432 and to first spray nozzles 440 at the first manifold 410. Similarly, the third valve assembly 54 opens the third inlet 110 to deliver water through second delivery lines 452 and to second spray nozzles 460 at the second manifold 420.

The first and second spray nozzles 440 and 460 are configured to selectively spray the product water onto a high-temperature radiator 470, which is thermally coupled to the fuel cell stack 14 for cooling thereof via a coolant circuit. The product water sprayed onto the radiator 470 at least partially evaporates against the relatively hot radiator coolant, thereby increasing heat dissipation and reducing the radiator coolant temperature further than can be accomplished by air alone. The radiator 470 may be disposed between an A/C condenser (not shown) and one or more fans 474 to further improve evaporation, cooling, and airflow across the radiator 470.

FIG. 4 is a table 500 that illustrates various modes available with the thermal management system 12. The table 500 reflects the five mode control strategy an lists exemplary approximate pressure and flow rate values. The values may be changed to accommodate different nozzles and switch points by adjusting the spring rates of the biasing members 64, 84 and 104, spring compression and inside diameters of the seal edges where it meets the tapered pin seal (FIG. 2A).

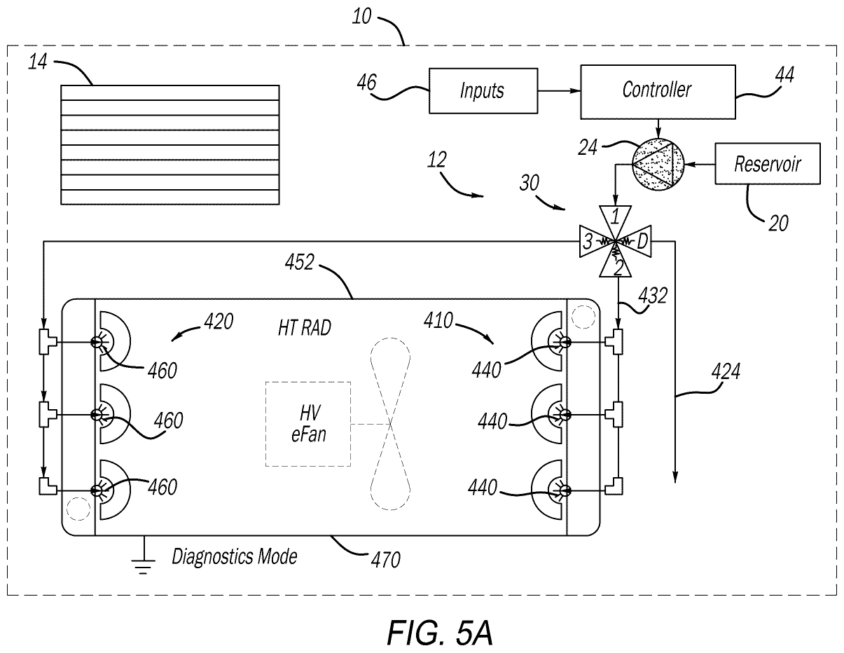

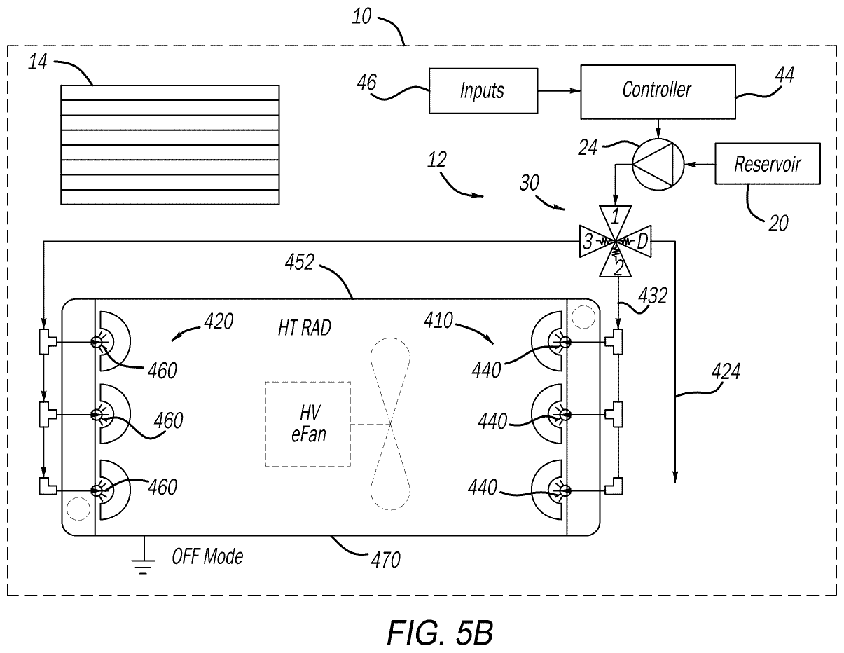

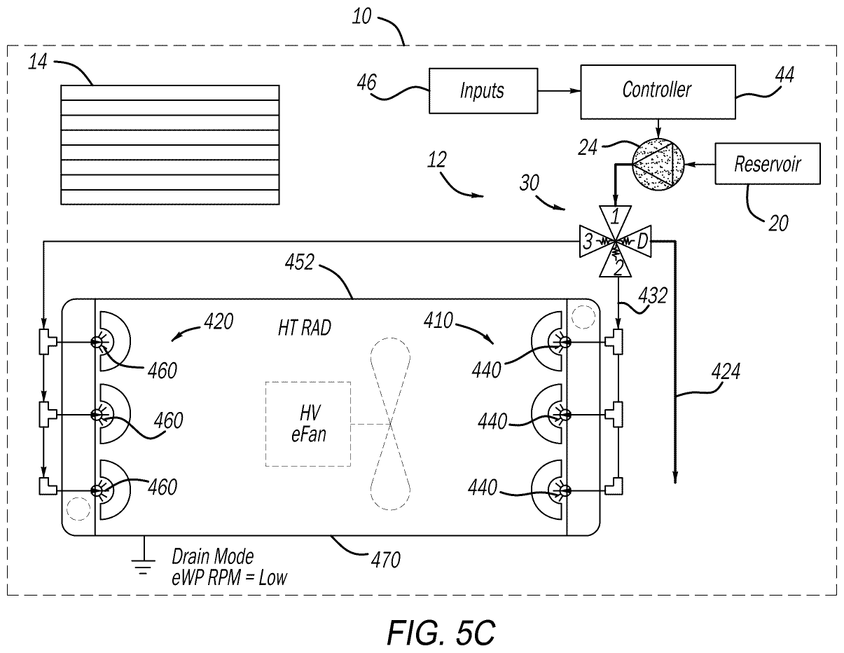

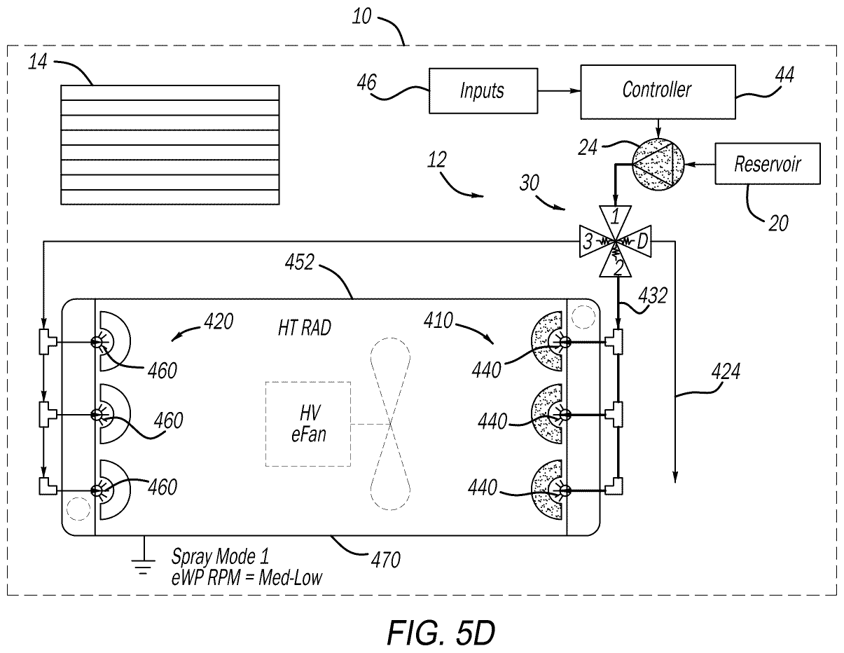

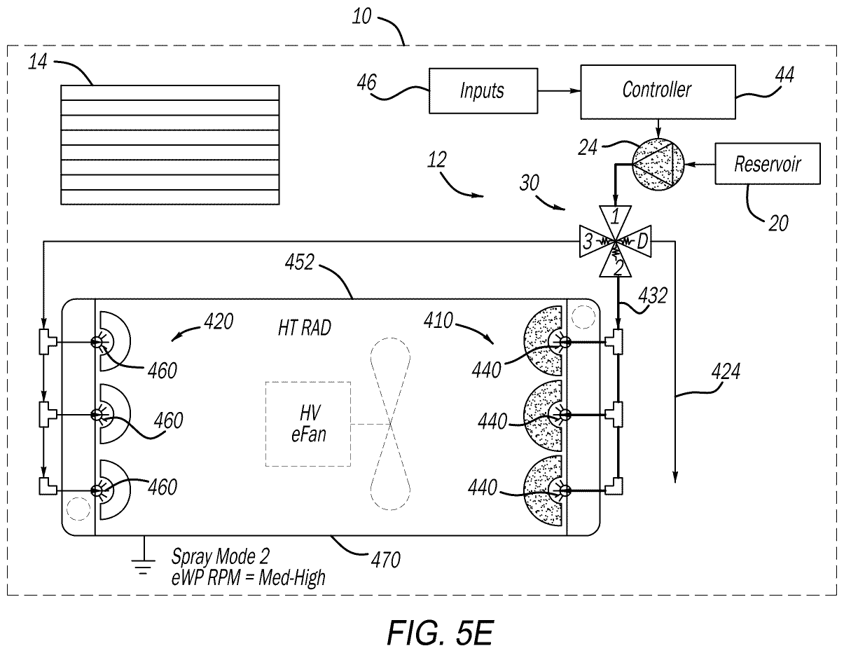

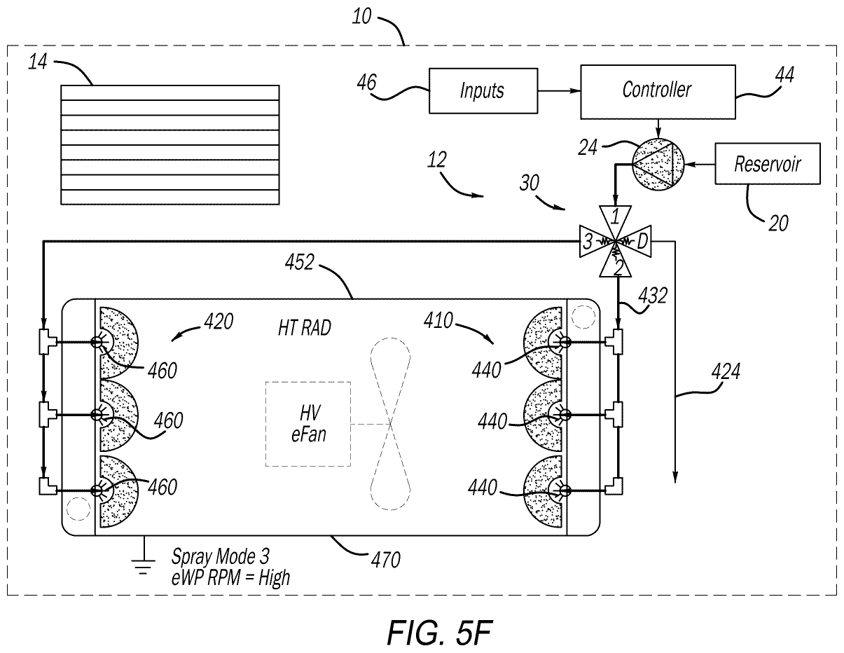

An exemplary mode of operation of the valve assembly 30 will now be described. Drain mode (FIG. 5C) will first be described. The controller 44 can initially command the pump 24 to operate at a low RPM causing the water to flow into the first valve assembly 50 where the water pressure is such that the first biasing member 64 biases the pin 62 away from the opening 72 but is not strong enough to close the pin 60 at the opening 70. Water therefore is permitted to flow into the drain line 424.

Mode 1 (FIG. 5D) will now be described. The controller 44 can command the pump 24 to operate at medium-low RPM causing the water pressure to overcome the first biasing member 64 such that the first outlet 72 closes. With the medium-low RPM, the water pressure causes the first pin 80 to lift off to the first inlet 90 at the second valve assembly 52 allowing water to flow out of the second outlet 92 and to the first spray manifold 410.

Mode 2 (FIG. 5E) will now be described. The controller 44 can command the pump 24 to operate at medium-high RPM causing the water pressure to (still) overcome the first biasing member 62 such that the first outlet 72 closes. With the medium-high RPM, the water pressure causes the second pin 80 to lift off of the second inlet 90 at the second valve assembly 52 allowing water to flow out of the second outlet 92 and to the first spray manifold 410. The water pressure flowing out of the spray nozzles 440 in Mode 2 (FIG. 5E) is greater than with Mode 1 (FIG. 5D).

A diagnostics mode is shown in FIG. 5A. In the diagnostics mode, the controller 44 can run various tests on the components of the thermal management system 12 such as by commanding the pump 24 to operate at various RPM's and determining the operation of the valve assembly 30 and spray manifolds 410, 420. FIG. 5B illustrates the thermal management system 12 in the OFF mode wherein the controller 44 does not command the pump 24 to operate.

Mode 3 (FIG. 5F) will now be described. The controller 44 can command the pump 24 to operate at high RPM causing the water pressure to (still) overcome the first biasing member 62 such that the first outlet 72 remains closed. With the high RPM, the water pressure causes the third pin 100 to lift off of the third inlet 110 at the third valve assembly 54 allowing water to flow out of the third outlet 112 and to the second spray manifold 420. Notably, with the high RPM, the water pressure (still) causes the second pin 80 to lift off the second inlet 90 at the second valve assembly 52 allowing water to flow out of the second outlet 92 and to the first spray manifold 410. A diagnostic mode and OFF mode are also illustrated at FIG. 4.

Described herein are systems and methods for thermal management of a fuel cell vehicle. The system directs water/air from the fuel cell stack exhaust to a condenser and subsequently to a water-gas separator pressure vessel followed by a liquid reservoir. The liquid water is selectively supplied to spray nozzles to direct the liquid water onto a high temperature radiator for increased cooling of the fuel cell stack.

It is appreciated that the valve assembly 30 described herein has four ports used to control distribution of liquid water produced in a fuel cell stack 14 onto a high temperature radiator 470, thereby increasing thermal performance. The valves provide N ports and N+1 operating modes in the version discussed. However, the present disclosure can be extended to N=5 with six modes and beyond.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A thermal management system for a vehicle having a fuel cell stack, the thermal management system comprising:
a radiator thermally coupled to the fuel cell stack;
a storage reservoir that stores liquid product water from the fuel cell stack;
a pump that pumps the liquid product water;
a main valve assembly that receives the liquid product water from the pump, the main valve assembly having a valve housing that selectively delivers the liquid product water to a drain and to a first spray manifold that sprays the liquid product water at the radiator, the valve assembly including:
a first valve assembly disposed in a drain valve chamber of the valve housing and having a first biasing member that biases a first pin against a first inlet, the first valve assembly selectively communicating the liquid product water to the drain; and
a second valve assembly disposed in a second valve chamber of the valve housing and having a second biasing member that biases a second pin against a second inlet, the second valve assembly selectively communicating the liquid product water to the first spray manifold, the first biasing member having a distinct spring rate from the second biasing member wherein a first water pressure opens the first inlet of the first valve assembly without the second valve assembly opening the second inlet; and
a controller that commands the pump to operate at a predetermined revolutions per minute (RPM) based on operating conditions to achieve the first water pressure.

2. The thermal management system of claim 1, wherein the controller commands the pump to increase RPM in a first Mode from the first water pressure to a second water pressure, wherein the second water pressure is higher than the first water pressure and causes the first valve assembly to close and the second valve assembly to open the second inlet.

3. The thermal management system of claim 1, further comprising:
a third valve assembly disposed in a third valve chamber of the valve housing and having a third biasing member that biases a third pin against a third inlet, the third valve assembly selectively communicating the liquid product water to a second spray manifold, the third biasing member having a distinct spring rate from the second biasing member wherein a third water pressure, higher than the first and second water pressures, opens the third valve assembly communicating the liquid product water to the second spray manifold.

4. The thermal management system of claim 1, wherein the first valve assembly includes a drain armature having a first scallop configuration defined on a perimeter thereof.

5. The thermal management system of claim 4, wherein the second valve assembly includes a second armature having a second scallop configuration defined on a perimeter thereof, the second scallop configuration being distinct from the first scallop configuration.

6. The thermal management system of claim 1, further comprising a first plurality of spray nozzles configured at the first spray manifold.

7. The thermal management system of claim 3, further comprising a second plurality of spray nozzles configured at the second spray manifold.

8. The thermal management system of claim 1, wherein the pump is a LIN pump that provides feedback to the controller indicative of a dry-run condition.

9. The thermal management system of claim 1, wherein the pump is a LIN pump that measures electrical current and voltage and provides a signal to the controller indicative of a pump RPM.

10. The thermal management system of claim 1, wherein the first pin is an upstream pin selectively biased against a first inlet, the first valve assembly further comprising a downstream pin that is selectively biased against a first outlet that leads to the drain.

11. The thermal management system of claim 10, wherein the upstream and downstream pins are positioned away from the first inlet and outlet, respectively with the first water pressure.

12. The thermal management system of claim 11, wherein the downstream pin moves to a closed position at the first outlet with the second water pressure.

13. The thermal management system of claim 1, wherein the valve housing comprises an upstream valve chamber at a first housing section that receives the liquid product water prior to entering any of the first and second valve assemblies formed at a second housing section.

14. The thermal management system of claim 13, wherein the first and second housing sections are ultrasonically welded together.
